(19) United States
(12) Patent Application Publication
(10) Pub. No.: US 2015/0347310 A1
(43) Pub. Date: Dec. 3, 2015

(54) Storage Controller and Method for Managing Metadata in a Cache Store

(71) Applicant: LSI Corporation, San Jose, CA (US)

(72) Inventors: Mark Ish, Sandy Springs, GA (US); Sumanesh Samanta, Bangalore (IN); Horia Simionescu, Foster City, CA (US); Saugata Das Purkayastha, Bangalore (IN)

(73) Assignee: LSI Corporation, San Jose, CA (US)

(21) Appl. No.: 14/292,301

(22) Filed: May 30, 2014

(51) Int. Cl. G06F 12/08; G06F 3/06

(52) U.S. Cl. CPC G06F 12/0895; G06F 3/0608; G06F 3/0631; G06F 3/064; G06F 3/0656; G06F 3/0679; G06F 2212/1044; G06F 2212/152; G06F 2212/2022; G06F 2212/214; G06F 2212/222; G06F 2212/604; G06F 2212/608; G06F 2212/7202; G06F 2003/0691

(57) ABSTRACT

A cache controller coupled to a cache store supported by a solid-state memory element uses a metadata update process that reduces write amplification caused by writing both cache data and metadata to the solid-state memory element. The cache controller partitions the solid-state memory element to include a metadata portion, a host data or cache portion and a log portion. Host write requests that include “hot” data are processed and recorded by the cache controller. The cache controller maintains first and second maps. A log thread combines multiple metadata updates in a single log entry block. Pending metadata updates are checked to determine when a commit threshold is reached. Thereafter, the pending metadata updates are written to the solid-state memory element and the maps are updated.

### TECHNICAL FIELD

The invention relates generally to data storage systems and, more specifically, to data storage systems employing a flash-based data cache.

### BACKGROUND

Some conventional computing systems employ a non-volatile memory device as a block or file level storage alternative for slower data storage devices to improve performance of the computing system and/or applications executed by the computing system. In this respect, because input/output (I/O) operations can be performed significantly faster to some non-volatile memory devices (hereinafter a “cache device” for simplicity) than from or to a slower storage device (e.g., a magnetic hard disk drive), use of the cache device provides opportunities to significantly improve the rate of I/O operations.

For example, in the system illustrated in FIG. 1, a data storage manager 10 controls a storage array 12 in a manner that enables reliable data storage. A host (computer) system 14 stores data in and retrieves data from storage array 12 via data storage manager 10. That is, a processor 16, operating in accordance with an application program or APP 18, issues requests for writing data to and reading data from storage array 12. Although for purposes of clarity host system 14 and data storage manager 10 are depicted in FIG. 1 as separate elements, it is common for a data storage manager 10 to be physically embodied as a card that plugs into a motherboard or backplane of such a host system 14.

Such systems may cache data based on the frequency of access to certain data stored in the data storage devices 24, 26, 28 and 30 of storage array 12. This cached or “hot” data, e.g., element B, is stored in a cache memory module 21, which can be a flash-based memory device. The element B can be identified at a block level or file level. Thereafter, requests issued by applications, such as APP 18, for the “hot” data are serviced by the cache memory module 21, rather than the storage array 12. Such conventional data caching systems are scalable and limited only by the capacity of the cache memory module 21. Accordingly, it can take a significant amount of time to fill the entire capacity of the cache.

A redundant array of inexpensive (or independent) disks (RAID) is a common type of data storage system that addresses the reliability by enabling recovery from the failure of one or more storage devices. It is known to incorporate data caching in a RAID system. In the system illustrated in FIG. 1, data storage manager 10 includes a RAID processing system 20 that caches data in units of blocks, which can be referred to as read cache blocks (RCBs) and write cache blocks (WCBs). The WCBs comprise data that host system 14 sends to the data storage manager 10 as part of requests to store the data in storage array 12. In response to such a write request from host system 14, data storage manager 10 caches or temporarily stores a WCB in one or more cache memory modules 21, then returns an acknowledgement message to host system 14. At some later point in time, data storage manager 10 transfers the cached WCB (typically along with other previously cached WCBs) to storage array 12. The RCBs comprise data that data storage manager 10 has frequently read from storage array 12 in response to read requests from host system 14. Caching frequently requested data is more efficient than reading it from storage array 12 each time host system 14 requests it, since cache memory modules 21 are of a type of memory, such as flash-based memory, that can be accessed much faster than the type of memory (e.g., disk drive) that data storage array 12 uses.

Flash-based memory offers several advantages over magnetic hard disks. These advantages include lower access latency, lower power consumption, lack of noise, and higher robustness to environments with vibration and temperature variation. Flash-based memory devices have been deployed as a replacement for magnetic hard disk drives in a permanent storage role or in supplementary roles such as caches.

Flash-based memory is a unique memory technology due to the sensitivity of reliability and performance to write traffic. A flash page (the smallest division of addressable data for read/write operations) must be erased before data can be written. Erases occur at the granularity of blocks, which contain multiple pages. Only whole blocks can be erased. Furthermore, blocks become unreliable after some number of erase operations. The erase before write property of flash-based memory necessitates out-of-place updates to prevent the relatively high latency of erase operations from affecting the performance of write operations. The out-of-place updates create invalid pages. The data in the invalid pages are relocated to new locations with surrounding invalid data so that the resulting block can be erased. This process is commonly referred to as garbage collection. To achieve the objective, valid data is often moved to a new block so that a block with some invalid pages can be erased. The write operations associated with the move are not writes that are performed as a direct result of a write command from the host system and are the source for what is commonly called write amplification. As indicated above, flash-based memories have a limited number of erase and write cycles. Accordingly, it is desirable to limit these operations.

In addition, as data is written to a flash-based memory it is generally distributed about the entirety of the blocks of the memory device. Otherwise, if data was always written to the same blocks, the more frequently used blocks would reach the end of life due to write cycles before less frequently used blocks in the device. Writing data repeatedly to the same blocks would result in a loss of available storage capacity over time. Consequently, it is important to use blocks so that each block is worn or used at the same rate throughout the life of the drive. Accordingly, wear leveling or the act of distributing data across the available storage capacity of the memory device generally is associated with garbage collection.

Flash-based storage devices are being deployed to support caches for data stores. In order to recover from power outages and other events or conditions, which can lead to errors and data loss, metadata or data about the information in the cache is desired to be stored in a persistent manner. Most applications take advantage of the flash-based storage device and use a portion of the available storage capacity to save the metadata in the one or more flash-based memory devices supporting the cache. However, such storage increases the write amplification as each new cache write includes a corresponding update to the metadata. Conventional systems achieve a write amplification score of approximately 2. That is, one block of metadata is written for every block of data written to the cache. Combining multiple metadata updates from multiple input output operations (IOs) is generally difficult because of the temporal relationships between metadata and the system data and the requirement not to decrease performance. In addition, cache lines that are logically sequential from the perspective of the O/S are not sequential in the flash-based cache for the described reasons. It follows that the metadata entries are distributed and not readily combinable.

### SUMMARY

Embodiments of a storage controller and method for managing metadata in a cache store are illustrated and described. In an example embodiment, a storage controller includes an interface for communicating with a host system, a processing system and a solid-state memory element coupled to the processing system via a bus. The processing system includes a processor and a local memory. The local memory stores a primary map, a secondary map, allocation logic, cache-write logic; map management logic, metadata management logic, and log logic. The primary map defines a first relationship between an index identifying a cache line and an identifier associated with an instance of a metadata block stored in the solid-state memory element. A secondary map defines a one-to-many relationship between the identifier associated with the instance of the metadata block and a combination of indexes identifying at least one cache lines. The allocation logic, when executed by the processor, divides a storage capacity of the solid-state memory element supporting the cache into first, second and third regions. The first region is arranged to store metadata blocks. The second region is arranged to store cache lines. The third region is arranged to store log entries. The cache-write logic, when executed by the processor, identifies when a write request is designated for storage in the cache, updates a cache line, and requests a log update. The metadata management logic, when executed by the processor, identifies when a cache line is written in the second region of the solid-state memory element and posts a log entry including at least one metadata block. The map logic, when executed by the processor directs the storage controller to maintain information in the primary and secondary maps.

In an example embodiment of a method for managing metadata operations in a cache supported by a solid-state memory element, the storage controller performs steps including allocating a first region of the solid-state memory element for the storage of metadata blocks, allocating a second region of the solid-state memory element different from the first region for the storage of cache lines, allocating a third region of the solid-state memory element for the storage of log entries, maintaining a primary map that defines a first relationship between an index identifying a cache line and an identifier associated with an instance of a metadata block, maintaining a secondary map that defines a second relationship between the identifier associated with the instance of the metadata bock and a combination of indexes identifying at least one cache lines, in response to a written cache line in the second region of the solid-state memory element, posting a request to a log update process, the log update process combining the requests to include at least one metadata instance, determining when a commit criteria is met and when the commit criteria is met, using the log entries to update an unused metadata block the primary map and the secondary map, otherwise waiting for a cache line to be written in the second region of the solid-state memory.

### BRIEF DESCRIPTION OF THE DRAWINGS

FIG. 1 is a block diagram illustrating a conventional cache device coupled to a host computer and a storage system.

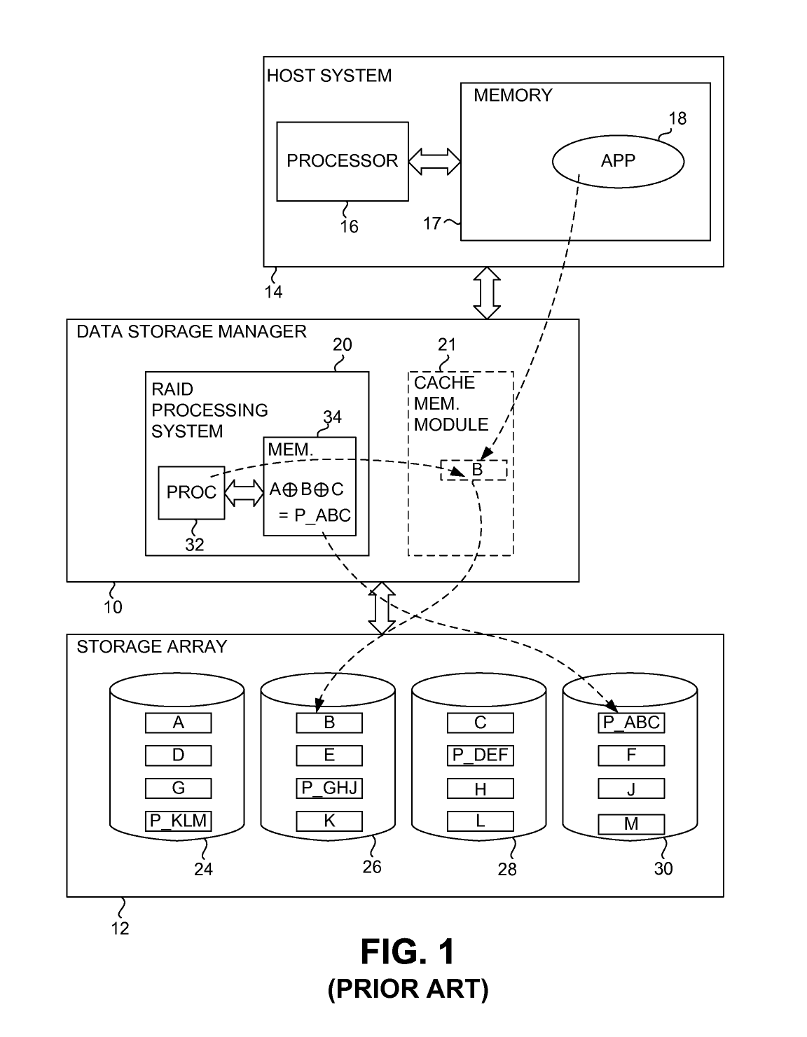

FIG. 2 is a block diagram illustrating an improved storage controller in accordance with an exemplary embodiment of the invention.

FIG. 3 is a schematic illustration of an embodiment of the cache store of FIG. 2.

FIG. 4 is a schematic illustration of an embodiment of the primary map of FIG. 2.

FIG. 5 is a schematic illustration of an embodiment of the secondary map of FIG. 2.

FIG. 6 is a flow diagram illustrating an embodiment of a method for processing host I/O requests.

FIG. 7 is a flow diagram illustrating an embodiment of a method for managing metadata.

FIG. 8 is a flow diagram illustrating an embodiment of a method for processing log updates when managing the cache store of FIG. 2.

### DETAILED DESCRIPTION OF AN ILLUSTRATIVE EMBODIMENT

In an exemplary embodiment, a cache or storage controller is communicatively coupled to a host system, a storage array and a solid-state memory element, which is used to support a cache store. The storage controller includes a processing system with at least one processor and a memory element. The memory element includes logic and data, which are used to manage data transfers directed by host commands. The cache or storage controller uses a metadata update process that reduces the number of write operations to update metadata in the solid-state memory element. As a result, write amplification caused by writing both cache data and metadata to the solid-state memory element is significantly reduced, which extends the operational life of the solid-state memory element.

The cache or storage controller partitions the solid-state memory element to include a metadata portion, a host data or cache portion and a log portion. Host write requests that include “hot” data or data frequently required by the host system are processed and recorded by the cache controller. A metadata entry includes a set of fields that retain information that identify characteristics of an identified cache line, which includes host data intended for storage in the storage array. The metadata entry information identifies the host logical drive as well as the logical block address of the information in the storage array. In addition, the metadata entry information indicates whether the entry is valid, and whether the information has been updated since the information to be stored in the storage array was cached.

The host data or cache portion of the solid-state memory element is used to store cache lines. Each entry or cache line in this portion of the solid-state memory element includes data that is intended for more permanent storage in the storage array that a copy of which is maintained in the cache as long as the data contained therein is frequently used by the host.

The log portion of the solid-state memory element stores information that is used by the cache or storage controller to protect the cached data. Log entries include a first field that identifies a log sequence, a second field that identifies the number of metadata entries that have been combined by the storage controller and each of the metadata entries. An additional field in the log portion of the solid-state memory element identifies the last log sequence that was written to the cache.

A log update thread combines multiple metadata updates in a single log entry block. Pending metadata updates are recorded in the storage controller memory and are checked to determine when a commit threshold is reached. The cache or storage controller generates and maintains primary and secondary maps. A primary map defines a relationship between a cache line index, a representation of a storage location in the second portion or region of the solid-state memory element and a metadata block identifier. The primary map enables the cache or storage controller to save metadata entries in any available location within the metadata region (i.e., within a metadata block) of the solid-state storage element. A secondary map defines a one-to-many relationship between each metadata block and respective identifiers or indexes of the cache lines stored in the identified metadata block. The secondary map further includes an entry that identifies the number of valid cache lines represented in the metadata stored in the metadata block.

The maps are updated only after a log of pending “hot” write requests reaches a desired number of entries. In an example embodiment, the maps are updated once an entire metadata block can be modified by information in the log. The desired number of entries is identified by a commit criteria identified when the storage capacity of recorded metadata instances exceeds the storage capacity of a metadata block. The log protects the data until the information in the respective maps is stored in the non-volatile memory element supporting the cache. As a result, the overhead associated with two or more write operations smaller in size than that of M metadata blocks is spread across the M writes. For two combinable IOs the write amplification drops from about 2 to 1.524. Further reductions in write amplification are possible as the number of combinable metadata entries increases.

In an embodiment of the method for managing metadata, the storage controller is arranged to identify a number of unused metadata blocks in the first region of the solid-state memory element, identify when the number of unused metadata blocks is below a threshold, and when the number of unused metadata blocks is below the threshold, the storage controller recycles a used metadata block.

The act of recycling includes saving valid cache line metadata entries to an alternative metadata block and marking the used metadata block as unused. The alternate metadata block can be a partially filled metadata block. Metadata entries stored in the first region include data arranged to identify at least one of a validity state, a used state, and whether data in the cache is different from corresponding data in a storage volume (i.e., whether the data is “dirty” data). In addition, metadata entries stored in the first region includes data arranged to identify at least one of a logical block address of a logical drive and a logical drive identifier that are provided by the host system. Data originating in the host is stored in the second region or host data region of the solid-state memory element. Log entries stored in the third region of the solid-state memory element include at least one metadata entry, a data field responsive to a number of metadata entries in the log entry, and a log sequence identifier. The third or log region of the solid-state memory element also includes a field that identifies that last log entry that was stored in the storage array or logical disk.

In an embodiment of the storage controller the first region is arranged to store metadata blocks each having P kbytes, the metadata blocks including metadata entries each having R bytes. In an example arrangement, P is the integer 4 and R is the integer 16.

In an embodiment, the metadata management logic, when executed by the processor, identifies a number of unused metadata blocks in the first region of the solid-state memory element, identifies when the number of unused metadata blocks is below a threshold and in response to the number of unused metadata blocks being below the threshold, recycles a used metadata block.

In an embodiment, the metadata management logic, when executed by the processor, saves valid cache line metadata entries to an alternative metadata block, marks the alternative metadata block as used when not so marked and marks a source metadata block as unused. The alternate metadata block may be partially filled or empty.

In an embodiment, the metadata management logic, when executed by the processor, performs a garbage collection process on a used block adjacent to the metadata block that received metadata. In addition, the metadata management logic identifies when no log update requests are pending and in response updates a log status.

In an embodiment, the log further includes information that defines the last log entry that was stored in the metadata region.

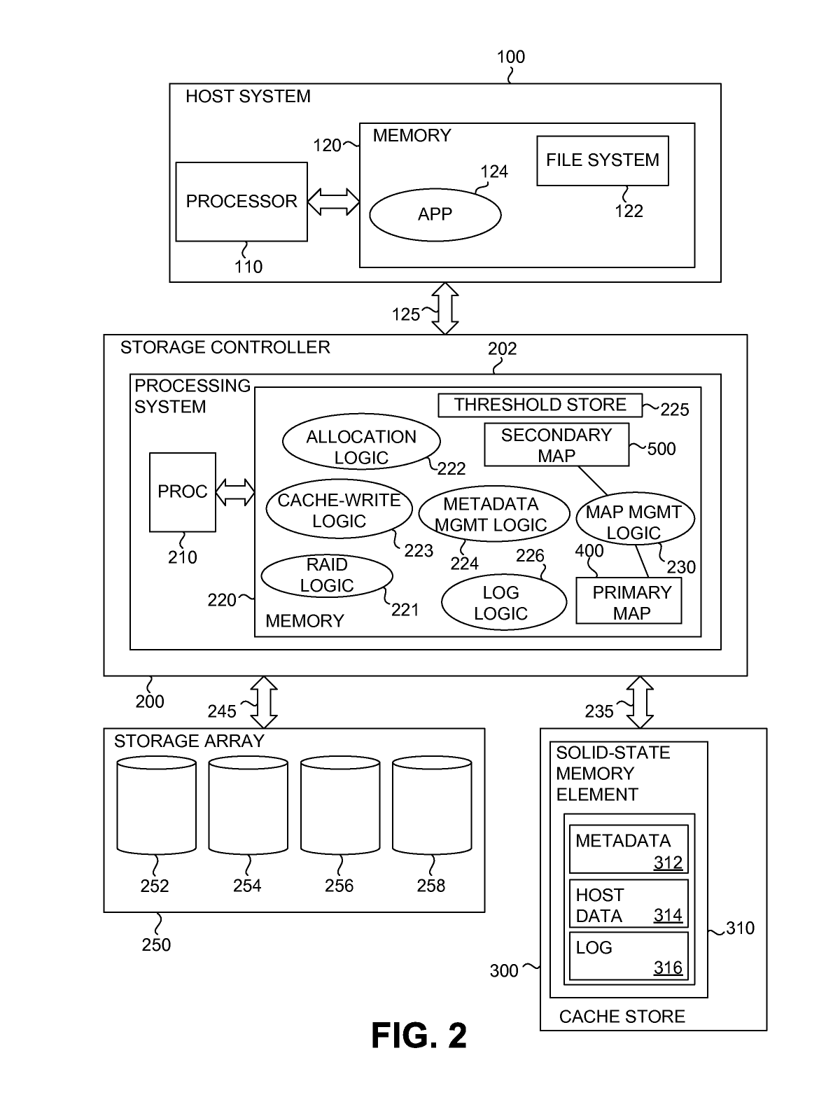

As illustrated in FIG. 2, in an illustrative or exemplary embodiment of computing environment, a host system 100 communicates with a storage controller 200 that controls data storage in a RAID manner in a storage array 250. Storage array 250 includes four storage devices 252, 254, 256 and 258, such as physical disk drives of PDDs. Although in the exemplary embodiment storage devices 252, 254, 256 and 258 comprise PDDs, the PDDs can be replaced by solid-state or flash memory modules. That the number of storage devices in storage array 250 is four is intended merely as an example, and in other embodiments such a storage array can include any number of storage devices. Although not described in detail herein for purposes of clarity, it should be understood that storage controller 200, in addition to operating as described below, operates to provide substantially conventional RAID protection for a host-based logical drive, such as, for example, RAID-5 protection, to storage array 250. As well understood in the art, RAID-5 (striping with rotated parity) can be used to protect a storage array having three or more storage devices.

Storage controller 200 communicates with storage array 250 via an interface 245, such as a bus, and also communicates with host system 100 (e.g., a computer) via another interface 125, such as another bus. Storage controller 200 can be physically embodied in a circuit card device that is, for example, pluggable into a motherboard or backplane (not shown) of host system 100. For example, storage controller 200 can have characteristics of a PCIe controller, where interface 125 is a PCIe bus.

Host system 100 stores data in and retrieves data from storage array 250 via storage controller 200. That is, a processor 110 in host system 100, operating in accordance with an application program 124 or similar software, initiates input/output (“I/O”) requests for writing data to and reading data from storage array 250. In addition to the application program 124, memory 120 further includes a file system 122 for managing data files and programs. Note that although application program 124 is depicted in a conceptual manner for purposes of clarity as stored in or residing in a memory 120, persons skilled in the art can appreciate that such software (logic) may take the form of multiple pages, modules, segments, programs, files, instructions, etc., which are loaded into memory 120 on an as-needed basis in accordance with conventional computing principles. Similarly, although memory 120 is depicted as a single element for purposes of clarity, memory 120 can comprise multiple elements. Likewise, although processor 110 is depicted as a single element for purposes of clarity, processor 110 can comprise multiple processors or similar processing elements.

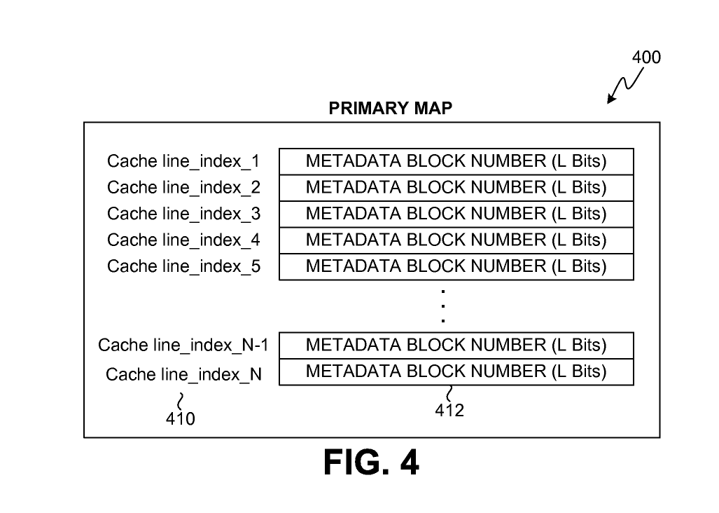

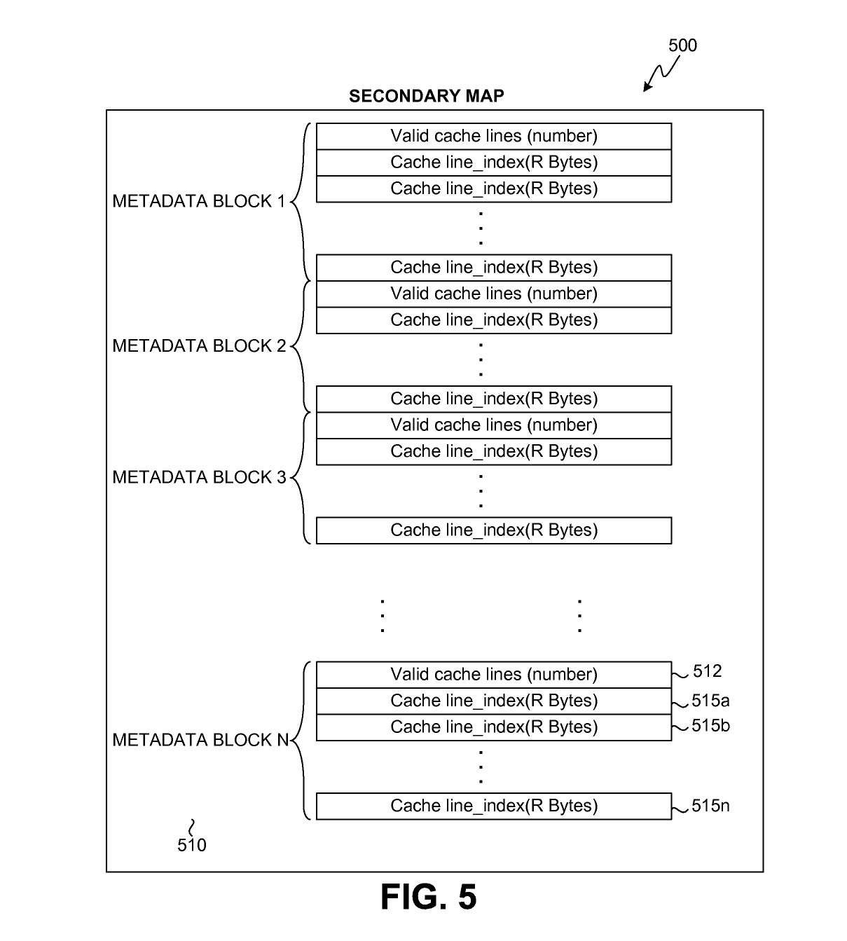

Storage controller 200 includes a processing system 202 comprising a processor 210 and memory 220. Memory 220 can comprise, for example, synchronous dynamic random access memory (SDRAM). Although processor 210 and memory 220 are depicted as single elements for purposes of clarity, they can comprise multiple elements. Processing system 202 includes the following logic elements: RAID logic 221, allocation logic 222, cache-write logic 223, metadata management logic 224, threshold store 225, log logic 226, map management logic 230, a primary map 400, and a secondary map 500. These logic elements or portions thereof can program or otherwise configure processing system 202 to enable the methods described below. The architecture and use of the primary map 400 is described in detail in association with the description of the illustration in FIG. 4. Similarly, the architecture and operation of the secondary map 500 is described in detail in association with the description of the illustration in FIG. 5. Threshold store 225 holds a value or a set of selectable values that can be used to identify a commit criteria or condition. For example, threshold store 225 may include information identifying a number of metadata log entries that should be collected and combined before committing or writing metadata blocks to the solid-state memory element 310.

The term “logic” or “logic element” is broadly used herein to refer to control information and data, including, for example, instructions, data structures, files, tables, etc., and other logic that relates to the operation of storage controller 200. Note that although the above-referenced logic elements are depicted in a conceptual manner for purposes of clarity as stored in or residing in memory 220, persons of skill in the art can appreciate that such logic elements may take the form of multiple pages, modules, segments, programs, files, instructions, etc., which can be loaded into memory 220 on an as-needed basis in accordance with conventional computing principles as well as in a manner described below with regard to caching or paging methods in the exemplary embodiment. Unless otherwise indicated, in other embodiments such logic elements or portions thereof can have any other suitable form, such as firmware or application-specific integrated circuit (ASIC) circuitry.

Storage controller 200 also communicates with a cache store 300 via an interface 235, such as a bus. As illustrated in FIG. 2, in an illustrative or exemplary embodiment of the computing environment, host system 100 is coupled to both the storage array 250 and a cache store 300 supported by a solid-state (e.g., flash) memory element 310. Solid-state memory element 310 is arranged to improve performance of applications such as APP 124 by strategically caching the most frequently accessed data in storage array 250 in the cache store 300. Storage controller 200 works together with host system 100 to identify and store frequently accessed data items stored in storage array 250 and store them in the cache store 300.

In the illustrated embodiment, the cache store 300 is shown as a separate device. However, the solid-state memory element(s) 310 supporting the cache store 300 can be physically embodied in an assembly that is integrated with the storage controller 200. In other alternative embodiments, the solid-state memory element 310 or elements can be physically embodied in an assembly that is pluggable into a motherboard or backplane (not shown) of host system 100 or in any other suitable structure.

In the illustrated embodiment various logic elements or modules are shown separate from one another as individual components of memory 220. In alternative embodiments one or more of the various programs, program segments, logic or modules may be integrated with each other in a cache storage manager. However arranged, the RAID logic 221 includes executable instructions that when executed by the processor 210, coordinate and manage a select RAID level storage scheme for host based data stored in the storage array 250. The RAID logic 221 is responsive to data received in the storage controller 200 from the host IO and confirmation information from the storage array 250. While preferred embodiments support RAID protection for host data stored in storage array 250, RAID protection and thus the RAID logic 221 is not required to enable the disclosed methods for managing metadata in a cache.

Allocation logic 222 includes executable instructions that when executed by the processor 210, assign separate regions or sections of contiguous addressable storage locations to store particular types of information. Allocation logic 222 may include rules and algorithms for calculating optimum sizes and placement for metadata 312, host data 314 and log entries 316 in accordance with one or more input parameters identifying characteristics of the solid-state memory element(s) 310 supporting the cache store 300.

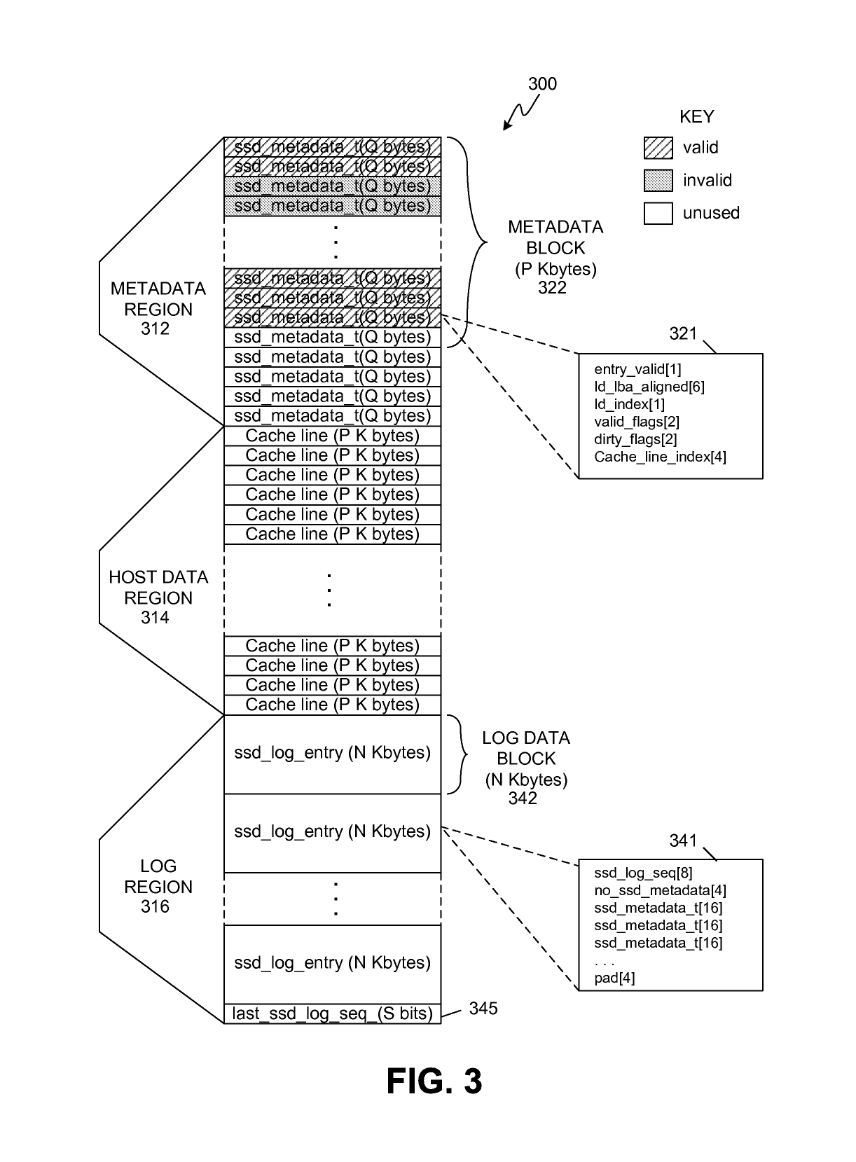

For example, the allocation logic 222 assigns or separates a first region, labeled metadata 312 in FIG. 2, of the storage capacity of the solid-state memory element 310 for metadata entries. The allocation logic 222 further assigns a second region, labeled host data 314 in FIG. 2 for the storage of cache lines and a third region, labeled log 316 in FIG. 2, for the storage of log entries. Details of the structure of the metadata entries and log entries are described below in association with the embodiments illustrated in FIG. 3.

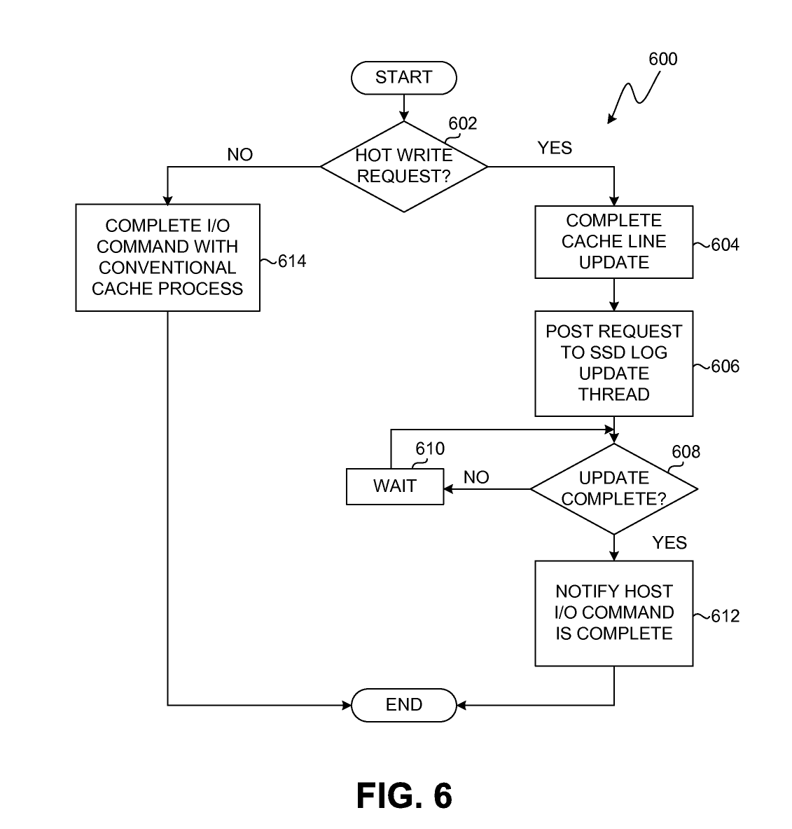

Cache-write logic 223 includes executable instructions that when executed by the processor 210, coordinate write requests identified by an algorithm executing in the storage controller 200 or the host system 100 as including information that is frequently required or used by the host system 100. The cache-write-logic 223 may be integrated in a cache manager arranged to process all IO operations (reads and writes) both to and from the solid-state memory element 310. When this is the case, the cache-write logic 223 may manage a set of lists, tables, buckets or other data entities or abstractions to identify “hot” data. Alternatively, the cache-write logic 223 may receive inputs from a separate application executing on the host system 100 and configured to identify such “hot” data. However arranged, the cache-write logic 223 directs the processor 210 to execute a method for processing IO requests as described in detail in association with the flow diagram of FIG. 6.

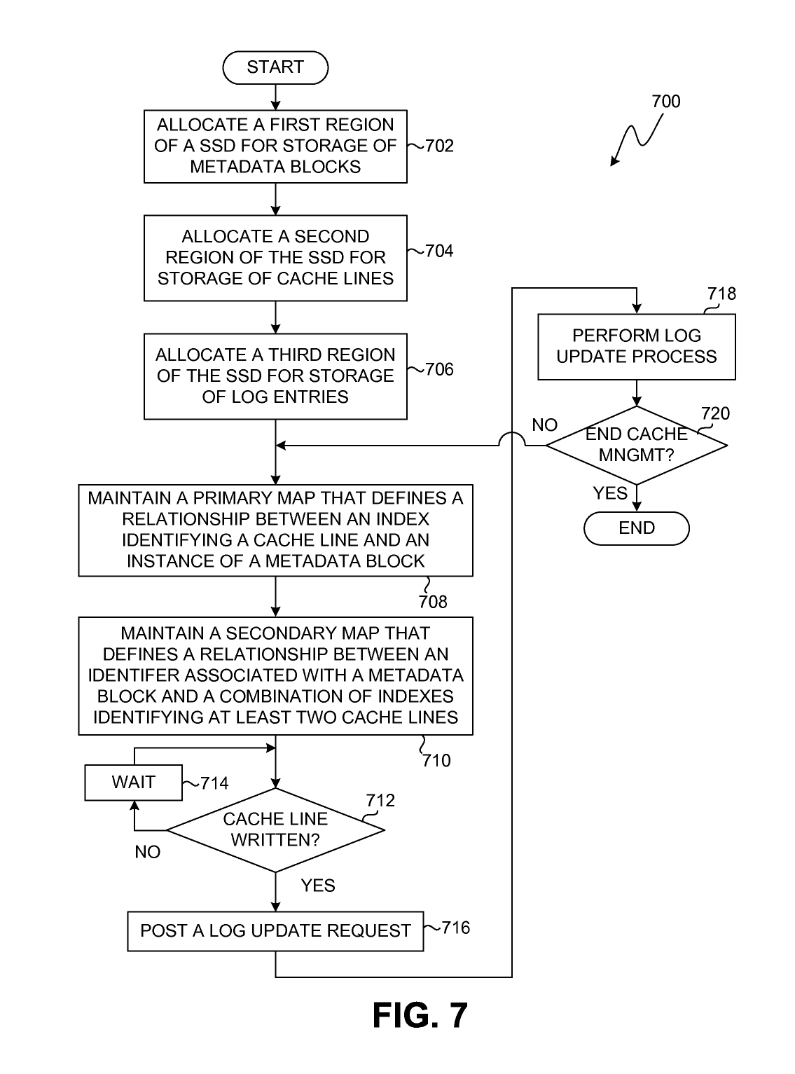

Metadata management logic 224 includes executable instructions that when executed by the processor 210, coordinate the collection and recording of metadata entries in the solid-state memory element 310. The metadata management logic 224 directs the processor 210 to execute a method for processing metadata identifying cache lines in the cache as described in detail below in conjunction with the flow diagram of FIG. 7.

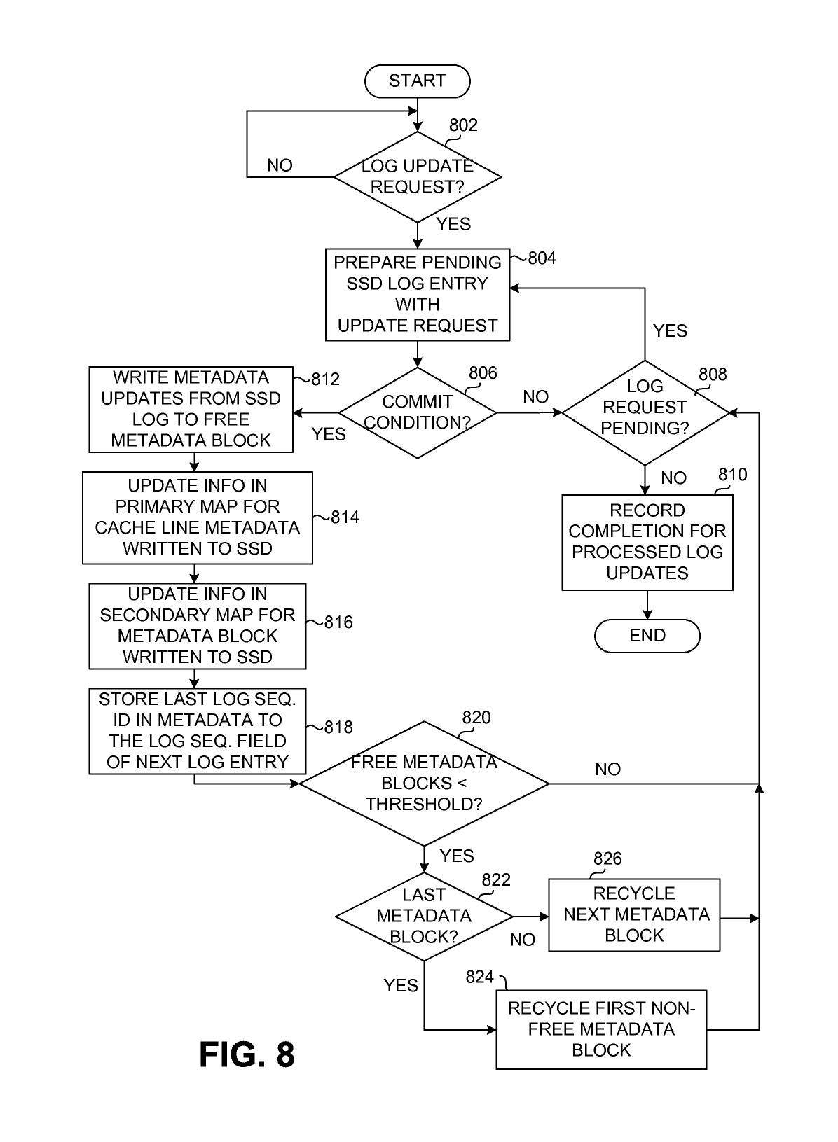

Log logic 226 includes executable instructions that when executed by the processor 210, coordinate the collection and recording of log entries in the solid-state memory element 310. The log logic 226 directs the processor 210 to execute a method for processing log entries and log updates in the cache store as described in detail below in conjunction with the flow diagram of FIG. 8.

Map management logic 230 functions in response to the log logic 226 and includes executable instructions that when executed by processor 210 update information stored in the primary map 400 and the secondary map 500. The primary map 400 includes information for cache line metadata that has been written to the solid-state memory element 310. The secondary map 500 includes information for metadata blocks that have been written to the solid-state memory element 310.

FIG. 3 is a schematic illustration of the cache store 300 of FIG. 2. Cache store 300 is partitioned or divided into at least three separate regions. A first or metadata region 312 is arranged to store SSD metadata entries 321 across metadata blocks 322. In the illustrated embodiment, each metadata entry 321 includes six fields or words. An entry valid field includes 1 B. A logical disk logical block aligned field includes 6 B of information. A logical disk index includes 1 B. The next two fields include valid flags and dirty flags of 2 B each. A cache line index field includes 4 B of information. As shown by the key in FIG. 3, each SSD metadata entry 321 conveys whether the associated information is used or unused, as well as, valid or invalid (when used). In other contemplated embodiments one or more of the fields or words in the SSD metadata entry may be adjusted in size to reflect a solid-state data storage element with a different storage capacity.

A second or host data region 314 includes cache lines. Each cache line includes information that is designated for storage at a later time in the storage array 250. In an example embodiment each cache line includes 64 kB of storage capacity for host data. In alternative embodiments, the storage capacity of a cache line may be larger or smaller than 64 kB as may be desired.

A third or log region 316 includes log data blocks 342 and a field or word labeled last_ssd_log_entry_seq 345 that includes a representation of the SSD log sequence of the last log data block which was written to the meta data block region 312 (FIG. 2). As indicated in FIG. 3, the field 345 may include S bits, where S is an integer. S bits can be used to identify 2^{S} separate log storage entries or log data block locations in the log region 316 in the solid state memory element 310 supporting the cache store 300. As indicated in FIG. 3, each log data block 342 includes an SSD log entry 341. In the illustrated embodiment, each SSD log entry 341 includes a set of fields or words. A ssd_log_seq field includes 8 B of information. The ssd_log_seq is incremented on each write to the log region and identifies the most recent log data block update. A no_ssd_metadata field includes 4 B of information identifying the number of metadata entries that are combined and stored in the SSD log entry 341. Thereafter, the indicated number of metadata entries 321 associated with the log data block 342 are included. As further indicated in FIG. 3, a pad field includes 4 B of information the contents of which may include a select pattern or other desired sequence of information to indicate the end of the log data block to the storage controller 200.

FIG. 4 is a schematic illustration of information in the primary map 400 introduced in FIG. 2. As shown in FIG. 4, each entry in the primary map 400 comprises two fields. A first field includes a cache line index 410. A second field includes a metadata block identifier 412. Each entry defines a many-to-one relationship between an instance of a cache line index 410 and a respective metadata block identifier 412. Multiple instances of a cache line index 410 may map to one metadata block identifier 412. For example, cache line index 1 through cache line index N may each be stored in a single metadata block.

Each cache line index is a unique address or identifiable storage location of the host data region 314 in the solid state memory element 310 supporting the cache store 300. In the illustrated embodiment, each respective instance of a cache line index is identified by an integer starting with the integer 1 and ending with the integer N.

Similarly, each metadata block 312 in the solid-state storage element 310 supporting the cache store 300, is associated with a unique identifier 412 in the primary map 400. In the illustrated embodiment, each metadata block is identified by a unique number represented by L bits, where L is an integer. The primary map 400 permits the metadata associated with a particular cache line in the solid-state storage element 310 to be stored at any desired storage location within the metadata region 312.

In the illustrated embodiment, the cache line index 410 precedes (when observing the illustration from left to right) the associated metadata block number 412. Alternatively, the metadata block 412 may be arranged to the left of the cache line index 410. However arranged, for an identified cache line, the associated metadata block is identified in the primary map 400.

The primary map 400 can have any number of map entries, such as, for example, 128 k. The allocation logic 222 reserves a region of the solid state memory element's storage capacity for metadata entries. Metadata entries are stored or arranged in metadata blocks. The term “metadata block” as used herein refers to a group or set of contiguous entries of Q bytes. In an example embodiment, where each cache line is 64 kB and the solid-state memory element 310 has a total storage capacity of 1 TB, a total of (1 TB/64 kB) or 16M cache lines may be stored. When Q is the integer sixteen and 16 B are used for cache line metadata, 256 MB of storage capacity is required to support cache lines. If the storage capacity for cache lines is overprovisioned by reserving twice the required storage capacity, 512 MB of storage capacity is allocated to metadata region 312. When each metadata block is 4 kB, (512 MB/4 kB) 128 k metadata blocks are available for storing cache line metadata 321 (FIG. 3). For the described example embodiment, the metadata blocks 412 can be represented by L bits where L is the integer seventeen. Alternative arrangements (i.e., metadata block capacities and number) of the fields in the primary map 400 are contemplated.

FIG. 5 is a schematic illustration of information in the secondary map 500 introduced in FIG. 2. As shown in FIG. 5, each entry in the secondary map 500 defines a set of one-to-many relationships between each instance of a metadata block 510 and cache lines 515a-515n stored in the corresponding metadata block in metadata region 312 of solid-state memory element 310 supporting the cache store 300. In addition to the association with the cache lines 515a-515n, each metadata block identifier 510 is also associated with a field 512 that includes a representation of the number of valid cache lines presently stored in the corresponding metadata block.

As indicated, a cache line index is a unique address or identifiable storage location of the host data region 314 in the solid state memory element 310 supporting the cache store 300. In the illustrated embodiment, each respective instance of a cache line index includes R bytes, where R is an integer. R bytes can be used to identify 2^{(R×8)} separate storage locations for cache lines. For example, when R is the integer 4, 2³² or 4,294,967,296 separate storage locations can be separately identified.

FIG. 6 is a flow diagram illustrating an embodiment of a method 600 for processing host IO commands that may be enabled or performed by the storage controller 200 of FIG. 2. As indicated in FIG. 6, the method 600 begins with decision block 602, where the storage controller 200 identifies if the present IO request is a “hot” write request. “Hot” write requests are sent to the cache-write logic 223. Host IO requests to read stored data or write data to the storage array 250, as indicated by the flow control arrow labeled, “NO” exiting decision block 602 are processed in accordance with a conventional cache process as indicated in block 614. Otherwise, when the storage controller 200 identifies a “hot” write request, the storage controller 200 completes a cache line update as shown in block 604 and posts a request to the solid-state device (SSD) log update thread as shown in block 606. Thereafter, as indicated in decision block 608, the storage controller 200 determines if the log update is complete. When the log update process has not completed, as indicated by the flow control arrow labeled, “NO” exiting decision block 608, the storage controller 200 waits for a designated time as shown in block 610 before returning to decision block 608. Otherwise, when the storage controller 200 receives an indication that the log update thread has completed, the storage controller 200 sends a notification to the host that the IO write request is complete.

FIG. 7 is a flow diagram illustrating an embodiment of a method 700 for managing metadata that may be enabled or performed by the storage controller 200 of FIG. 2. As indicated in FIG. 7, the method 700 begins with block 702 where a first region or metadata region 312 (FIG. 3) of a solid-state memory element or SSD 310 is allocated for the storage of metadata entries 321. As described in association with an exemplary embodiment, 128 k metadata blocks of 4 kB each are arranged to store SSD metadata entries 321 each comprising 16 B of data arranged in multiple fields. In block 704, a second region or host data region 314 (FIG. 3) of SSD 310 is allocated for the storage of cache line entries. As described in association with an exemplary embodiment, a desired number of cache line entries each comprising 64 kB are arranged for storage of “hot” host data that will be transferred at some later time to the data storage elements supporting the storage array 250 (FIG. 2). As indicated in block 706, a third region or log region 316 (FIG. 3) is allocated for the storage of log entries 341. As described in association with an exemplary embodiment, 128 k log data blocks of 4 kB each are arranged to store SSD log entries. In addition to the log data blocks 342, the log region 316 includes a field for recording a last used SSD log sequence 345.

As indicated in block 708, the storage controller 200 maintains a primary map 400 that defines a relationship between an index identifying a cache line and an identified metadata block 322 (FIG. 3). In block 710 the storage controller 200 maintains a secondary map 500 that defines a relationship between an identifier associated with a metadata block 322 and a combination or set of indexes identifying at least one cache lines. As indicated in decision block 712 and wait statement 714, the storage controller 200 waits for a host IO request to direct the storage controller 200 to write a cache line to the solid-state memory element 310 (FIG. 3). When a cache line is written, as indicated in block 716, the storage controller 200 posts a log update request. In block 718 the storage controller 200 performs a log update process, which is described in association with FIG. 8. In decision block 720 the storage controller 200 determines whether it has received an indicator directing the storage controller 200 to end cache management. When the storage controller 200 determines that the cache management process should remain active, the storage controller repeats the functions associated with blocks 708 through 718.

FIG. 8 is a flow diagram illustrating an embodiment of a method 800 for processing cache log updates that may be enabled or performed by the storage controller 200 of FIG. 2. As indicated in FIG. 8, the method 800 begins with decision block 802, where the storage controller 200 identifies when a log update request exists. When a cache log update request exists, the storage controller 200 prepares a pending SSD log entry in response to the cache log update request, as indicated in block 804. Thereafter, as indicated in decision block 806, the storage controller 200 determines when a commit condition has been met. When a commit condition has not been met, the storage controller 200 determines if a log request is pending, as indicated in decision block 808. When a log request is pending, the storage controller 200 prepares another SSD log entry and repeats the functionality in block 804, block 806 and block 808 until the commit condition is detected. When the commit condition is not detected and a log request is not pending, as indicated in block 810, the storage controller 200 records a completion status for the processed log updates and the method 800 terminates.

When the commit condition is detected, the storage controller 200 writes metadata updates from the SSD log to a free metadata block in the meta data block region 312 of the solid-state storage element or SSD 310, as indicated in block 812. As indicated in block 814, the storage controller 200 updates information in the primary map 400 for cache line data that was written to the SSD 310 in block 812. As indicated in block 816, the storage controller 200 updates information in the secondary map 500 for metadata blocks written to the SSD 310 in block 812. Thereafter, as indicated in decision block 818, the storage controller 200 stores or updates information in the last SSD log sequence field which was written to the metadata block region 312 in the SSD log sequence field of the next log entry 341. Thereafter, the storage controller checks if the number of free metadata blocks is less than a threshold in decision block 820. When the number of free metadata blocks is above (or equal to) the threshold, the storage controller 200 continues with the query in decision block 808. Otherwise, when the number of free metadata blocks is below the threshold, the storage controller 200 determines whether the process has reached the last metadata block. When the next metadata block is the last metadata block, as determined by the query in decision block 822, the storage controller 200 recycles the first non-free metadata block, as indicated in block 824 and updates the status of the recycled metadata block as free before continuing with the check in decision block 808. Otherwise, when the last metadata block has not been reached and additional metadata blocks are available, the storage controller 200 performs a recycle process on the next metadata block, as indicated in block 826 before continuing with the check in decision block 808.

It should be understood that the flow diagrams of FIGS. 6-8 are intended only to be exemplary or illustrative of the logic underlying the described method. In various embodiments, data processing systems including cache processing systems or cache controllers can be programmed or configured in any of various ways to enable the described methods. The steps or acts described above can occur in any suitable order or sequence, including in parallel or asynchronously with each other. Steps or acts described above with regard to FIGS. 6-8 can be combined with others or omitted in some embodiments. Although depicted for purposes of clarity in the form of flow diagrams, the underlying logic can be modularized or otherwise arranged in any suitable manner. Persons skilled in the art will readily be capable of programming or configuring suitable software or suitable logic, such as in the form of an application-specific integrated circuit (ASIC) or similar device or combination of devices, to effect the above-described methods. Also, it should be understood that the combination of software instructions or similar logic and the local memory 220 or other memory in which such software instructions or similar logic is stored or embodied for execution by processor 210, comprises a “computer-readable medium” or “computer program product” as that term is used in the patent lexicon.

It should be noted that the claimed storage controller and method for managing metadata have been illustrated described with reference to one or more exemplary embodiments for the purpose of demonstrating principles and concepts. The claimed storage controller and method for managing metadata are not limited to the illustrated embodiments. As will be understood by persons skilled in the art, in view of the description provided herein, many variations may be made to the embodiments described herein and all such variations are within the scope of the claimed storage controller and method for managing metadata.

What is claimed is:

1. A method for managing metadata operations in a cache supported by a solid-state memory element, the method comprising:
allocating a first region of the solid-state memory element for the storage of metadata blocks;
allocating a second region of the solid-state memory element different from the first region for the storage of cache lines;
allocating a third region of the solid-state memory element for the storage of log entries;
maintaining a primary map that defines a first relationship between an index identifying a cache line and an identifier associated with an instance of a metadata block;
maintaining a secondary map that defines a second relationship between the identifier associated with the instance of the metadata bock and a combination of indexes identifying at least one cache lines;
in response to a written cache line in the second region of the solid-state memory element, posting a request to a log update process, the log update process combines the requests to include at least one metadata instance;
determining when a commit criteria is met; and
when the commit criteria is met, using the log entries to update an unused metadata block, the primary map and the secondary map, otherwise waiting for a cache line to be written in the second region of the solid-state memory.

2. The method of claim 1, further comprising:
identifying a number of unused metadata blocks in the first region of the solid-state memory element;
identifying when the number of unused metadata blocks is below a threshold;
when the number of unused metadata blocks is below the threshold, recycling a used metadata block.

3. The method of claim 2, wherein recycling the used metadata block includes saving valid cache line metadata entries to an alternative metadata block and marking the used metadata block as unused.

4. The method of claim 3, wherein the alternate metadata block is a partially filled metadata block.

5. The method of claim 1, wherein an instance of a cache line index is associated with a respective metadata block identifier.

6. The method of claim 1, wherein metadata stored in the first region includes data arranged to identify at least one of a validity state, a used state, and whether data in the cache is different from corresponding data in a storage volume.

7. The method of claim 1, wherein metadata stored in the first region includes data arranged to identify at least one of a logical block address of a logical drive and a logical drive identifier.

8. The method of claim 1, wherein data originating in a host is stored in the second region.

9. The method of claim 1, wherein the log entries include at least one metadata entry, a data field responsive to a number of metadata entries, and a counter.

10. The method of claim 1, wherein the third region includes a field that identifies that last log entry that was stored in the first region during commit.

11. The method of claim 1, wherein the commit criteria is a function of both a size of a metadata entry and a size of a metadata block.

12. A storage controller for reducing write amplification to a cache, the storage controller, comprising:
an interface for communicating with a host system, the interface providing data and command signals to the data storage controller from the host system;
a processing system including a processor and a memory and coupled to the interface, the memory having stored therein a primary map, a secondary map, allocation logic, cache-write logic; map management logic, metadata management logic, and log logic; and
a solid-state memory element coupled to the processing system by a bus; wherein the primary map defines a first relationship between an index identifying a cache line and an identifier associated with an instance of a metadata block;
wherein the secondary map defines a one-to-many relationship between the identifier associated with the instance of the metadata block and a combination of indexes identifying at least one cache lines;
wherein the allocation logic when executed by the processor divides a storage capacity of a solid-state memory element supporting the cache into first, second and third regions, the first region for the storage of metadata blocks, the second region for the storage of cache lines, the third region for the storage of log entries;
wherein the cache-write logic when executed by the processor identifies a host write request designated for storage in the cache, updates a cache line, and requests a log update;
wherein the metadata management logic in response to a written cache line in the second region of the solid-state memory element, posts a log entry in the third region of the solid-state memory element, the log entry including at least one metadata block.

13. The storage controller of claim 12, wherein the first region is arranged to store metadata blocks each having P kbytes, the metadata blocks including metadata entries each having Q bytes.

14. The storage controller of claim 13, wherein P and Q are integers and the commit criteria is a function of both P and Q.

15. The storage controller of claim 12, wherein the metadata management logic when executed by the processor identifies a number of unused metadata blocks in the first region of the solid-state memory element, identifies when the number of unused metadata blocks is below a threshold and in response to the number of unused metadata blocks being below the threshold, recycles a used metadata block.

16. The storage controller of claim 15, wherein the metadata management logic when executed by the processor saves valid cache line metadata entries to an alternative metadata block, marks the alternative metadata block as used when not so marked and marks a source metadata block as unused.

17. The storage controller of claim 16, wherein the alternate metadata block is a partially filled metadata block.

18. The storage controller of claim 15, wherein the metadata management logic when executed by the processor performs a garbage collection process on a used block adjacent to the metadata block that received metadata.

19. The storage controller of claim 12, wherein the log further includes information that defines the last log entry that was stored in the first region during commit.

20. The storage controller of claim 12, wherein the metadata management module includes logic that when executed by the processor identifies when no log update requests are pending and in response updates a log status.
